(19) United States
(12) Patent Application Publication
(10) Pub. No.: US 2008/0312361 A1
(43) Pub. Date: Dec. 18, 2008

(54) Reactive Polyurethane Hot-Melt Formulations, Processes for Preparing the Same, and Uses Therefor

(75) Inventors: Matthias Wintermantel, Bergisch Gladbach (DE); Peter Reichert, Dormagen (DE); Eduard Mayer, Dormagen (DE); Marc Christian Leimenstoll, Hilden (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/137,778

(22) Filed: Jun. 12, 2008

(30) Foreign Application Priority Data
Jun. 16, 2007 (DE) 102007027801.4

(51) Int. Cl. C08L 75/06; C08K 5/521; C08K 5/053

(52) U.S. Cl. 524/147; 524/590; 524/323

(57) ABSTRACT

Hot-melt adhesive formulations comprising a polyurethane and a nucleating agent, preferably wherein the polyurethane comprises a reaction product of (a) a diisocyanate component and (b) a polyol component, wherein the diisocyanate component comprises one or more selected from the group consisting of aromatic diisocyanates, aliphatic diisocyanates, araliphatic diisocyanates, cycloaliphatic diisocyanates, and mixtures thereof, and wherein (a) and (b) are present in a ratio such that a molar ratio of NCO to OH is greater than 1; processes for preparing the same; compositions containing such formulations; and uses therefor.

### BACKGROUND OF THE INVENTION

Reactive polyurethane hot-melts (also referred to hereafter as hot-melt adhesive systems or PUR hot-melts) are a fast-growing group of products within the applications of polyurethanes in the adhesives sector. They can be synthesized using linear polyesterpolyols and/or polyetherpolyols in combination with an excess of polyisocyanates, preferably diisocyanates.

Some advantages of this class of products lie especially in the absence of solvent, in the possibility of applying the products hot with relatively low viscosities, in nevertheless obtaining high initial strength and in obtaining, after a relatively short time because of the further reaction with moisture, adhesive compounds with a very high thermal stability well above the application temperatures, and with excellent solvent resistance.

An essential feature of a good property profile for reactive polyurethane hot-melts is their ability to develop cohesive strength (initial strength) very rapidly on cooling, enabling the joined parts to be handled immediately after joining. For many applications, a particularly rapid development of strength is necessary, for example, to allow rapid further processing when cycle times are short, or to be able to take up restoring forces of the substrates without separation phenomena occurring.

As with all hot-melts, physical phenomena are responsible for the development of initial strength, since no substantial chemical processes take place within the space of seconds or minutes. These physical processes are on the one hand the sharp, continuous viscosity increase resulting from the drop in temperature, and on the other hand—when using crystalline components—a recrystallization effect leading to a sudden increase in strength.

The actual curing of reactive PUR hot-melts, i.e. the crosslinking reaction of the components with one another, takes place over hours to days through reaction of the isocyanate groups with water from the surroundings, or from the substrates which have been glued together, to form polyurea. The ability of PUR hot-melts to melt or dissolve in solvents is then limited. The cured adhesives therefore have a good thermal stability and resistance to chemicals such as plasticizers, solvents, oils or fuels.

To develop initial strength rapidly, reactive PUR hot-melts are prepared using polyols whose concentration in the hot-melt is sufficiently high and whose first-order or second-order transition (Tm or Tg) takes place at relatively high temperatures. It is necessary here to ensure that the first-order or second-order transition also takes place in a formulated hot-melt and is not suppressed by e.g. the miscibility of the crystallizing polyol in the overall system.

Hot-melts based on partially crystalline polyesters, as described e.g. in DE 38 27 224 A1, are distinguished by a very short open assembly time and a rapid associated development of initial strength. This is achieved e.g. by using esters based on dodecanedioic acid, which are known to have very rapid recrystallization kinetics and a high melting point.

Increasing the transition temperature and heat of recrystallization of high-molecular, partially crystalline, thermoplastic polymers, e.g. polyolefins or polyesters, by adding nucleating agents is described in, e.g., WO 2005/066256. This makes it possible e.g. to improve the demouldability and hence the cycle times in injection moulding.

The effect of a nucleating agent on the initial strength of high-molecular, solvent-containing, thermoplastic polyurethane elastomers was described in the publication “Initial Bond Strength of Polyurethane Contact Adhesives” (Adv. Urethane Sci. Tec., 1992, 11, 192-216). The tests were carried out exclusively on solvent-based polyurethane systems with a solids content of 22% or 28%. However, the results described in said publication for these solvent-based systems give no information on how nucleating agents behave in hot-melt adhesive systems that are substantially solvent-free.

It is thus unknown how nucleating agents might affect the recrystallization behavior of hot-melt adhesive systems based on low-molecular NCO-terminated prepolymers containing crystalline or partially crystalline and/or amorphous polyol components.

PUR hot-melts are used e.g. for glueing wood materials. The hot-melt adhesive systems used for glueing wood elements have the disadvantage of not increasing the cohesive strength of the wood when they have been applied to the corresponding wood elements and have hardened. An examination of glued wood elements has in fact revealed that, after complete curing of the hot-melt, the adhesion due to the hot-melt adhesive system is not critical and the ultimate strength is generally determined by the stability of the wood. In other words, the wood cracks before the cohesion due to the hot-melt adhesive system breaks down. It would thus be preferable in this case to use adhesive systems which, after curing, interact with the corresponding wood materials in such a way that the wood material itself is also strengthened (e.g. against cracking), for example by penetration of the adhesive system into the wood.

Accordingly, there is a demand not only for adhesive systems that allow a more rapid development of initial strength, but also for adhesive systems that, in the cured state, simultaneously increase the strength of the wood elements used.

### BRIEF SUMMARY OF THE INVENTION

The invention relates generally to polyurethane-containing hot-melt adhesives with improved properties, to formulations containing these hot-melt adhesives, to processes for the preparation of the hot-melt adhesives or the formulations, and to their use.

The present invention relates in particular to polyurethane-containing hot-melt adhesives which comprise an inorganic and/or organic nucleating agent(s). The present invention also provides formulations containing the hot-melt adhesives, processes for the preparation of the hot-melt adhesives or formulations, and their use.

One object of the invention preferably includes modifying formulations of reactive polyurethane hot-melts in such a way that the initial strength develops more rapidly. To achieve this, the formulation should have a higher recrystallization temperature of the crystalline and/or partially crystalline polyol component in the reactive polyurethane hot-melt. Furthermore, when used for glueing wood materials, the formulations should preferably increase the strength of the wood material so that cracking, for example, can be avoided.

It has now been found, surprisingly, that hot-melt adhesive systems based on crystalline or partially crystalline polyesterpolyols, or mixtures thereof with crystalline, partially crystalline, amorphous or liquid polyols or other components, and comprising inorganic or organic nucleating agents are distinguished from formulations not comprising nucleating agents by a particularly rapid development of initial strength and an increased ultimate strength of the glued wood elements.

This is particularly surprising because the recrystallization temperature and heat of recrystallization of the pure polyesters barely differ whether nucleating agent is added or not, as indicated by the DSC experiments shown in Table 2 presented below.

The present invention thus provides polyurethane-containing hot-melt adhesives which comprise at least one nucleating agent.

One embodiment of the present invention includes hot-melt adhesive formulations comprising a polyurethane and a nucleating agent.

Another embodiment of the present invention includes processes comprising: providing a polyol component, a diisocyanate component, and a nucleating agent, wherein the diisocyanate component is present in an excess and is selected from aromatic, aliphatic, araliphatic and cycloaliphatic diisocyanates; and mixing the polyol component, the diisocyanate component, and the nucleating agent to form a polyurethane-containing hot-melt adhesive formulation.

Another embodiment of the present invention includes compositions comprising a hot-melt adhesive formulation comprising a polyurethane and a nucleating agent, and one or more additives selected from the group consisting of catalysts that activate reaction with moisture, fillers, dyestuffs, resins, reactive and non-reactive polymers and extending oils.

Other embodiments of the present invention includes processes for preparing such compositions by mixing a hot-melt adhesive formulation in accordance with any of the various embodiments of the invention and one or more additives, as well as methods of using a hot-melt adhesive formulation in accordance with any of the various embodiments of the invention as a sealant, coating, foam or adhesive, especially hot-melt adhesive, assembly adhesive for the provisional fixing of components, bookbinding adhesive or adhesive for the production of crossbottom valve sacks, for the production of composite films and laminates or as an overlapping edge band.

The polyurethane-containing hot-melt adhesives according to the invention differ from the thermoplastic polyurethane elastomers in the publication “Initial Bond Strength of Polyurethane Contact Adhesives” (Adv. Urethane Sci. Tec., 1992, 11, 192-216) at least in that the hot-melt adhesive systems according to the invention are not solvent-based as described in the state of the art. The systems described in the state of the art have a solids content of 22% or 28%.

The results from the state of the art, which relates to solvent-based systems, are not expected to be applicable to the polyurethane-containing hot-melt adhesives according to the invention because the systems are completely different from one another. When nucleating agents are used in solvent-based systems, the latter exhibit a high mobility on account of the markedly lower viscosity. The corresponding molecules of adhesive can thus attach themselves very readily to the nucleating agents, so they crystallize out more easily. Because the mobility of nucleating agents in systems based on hot-melt adhesives is very restricted, those skilled in the art cannot assume that the results described for solvent-based systems in the state of the art will also be applicable to hot-melt adhesive systems.

Solvents which may be present in the polyurethane-containing hot-melt adhesives according to the invention may originate from the preparation of the corresponding constituents, i.e. the polyesters and isocyanates. It is therefore perhaps conceivable for glycols and acids, used in the polyester preparation, and amines, used in the isocyanate preparation, to be present, although these low-molecular residues account for a substantially negligible proportion of the hot-melt adhesive system according to the invention.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a nucleating agent” herein or in the appended claims can refer to a single agent or more than one agent. Additionally, all numerical values, unless otherwise specifically noted, are understood to be modified by the word “about.”

In various preferred embodiments of the present invention, a polyurethane-containing hot-melt adhesive is understood as meaning a system having a solvent content of less than 10 wt. %, particularly preferably of less than 8 wt. %, particularly of less than 6 wt. %, especially of less than 4 wt. %, more especially of less than 2 wt. %, even more especially of less than 1 wt. % and even more especially of less than 0.5 wt. %, based in each case on the hot-melt adhesive system.

Suitable nucleating agents which can be used in the polyurethane-containing hot-melt adhesives according to the invention can be an organic and/or inorganic nucleating agents.

In various preferred embodiments of the present invention, the polyurethane-containing hot-melt adhesives can be obtained by reacting:
(A) at least one aromatic, aliphatic, araliphatic and/or cycloaliphatic diisocyanate, preferably with a free NCO group content of 5 to 60 wt. %, particularly preferably of 20 to 55 wt. % and very particularly preferably of 30 to 50 wt. % (based on A), and
(B) a polyol or polyol mixture containing at least one crystallizing polyol, wherein the ratio of A to B is chosen such that the molar ratio of NCO to OH is >1, preferably from 1.2 to 4.0 and particularly preferably from 1.3 to 3.0, and
(C) at least one organic and/or inorganic nucleating agent in proportions of 0.001 to 10, preferably of 0.01 to 1.0 and particularly preferably of 0.05 to 0.5 wt. % (based on A+B).

The invention also provides formulations comprising the polyurethane-containing hot-melt adhesives according to the invention, and the use of the polyurethane-containing hot-melt adhesives or formulations according to the invention as e.g. sealants, coatings, foams and adhesives, especially hot-melt adhesives. The present invention also provides a process for the preparation of the polyurethane-containing hot-melt adhesives and/or formulations according to the invention.

Diisocyanate component A):

Examples of suitable diisocyanates which can be used as component A) in the various embodiments of the present invention include those with isocyanate contents of 5 to 60 wt. % (based on component A)) and with aliphatically, cycloaliphatically, araliphatically and/or aromatically bonded isocyanate groups, such as, e.g., 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanato-dicyclohexylmethane, 1-isocyanato-1-methyl-4(3)-isocyanatomethylcyclohexane, bis-(isocyanatomethyl)norbornane, 1,3- and 1,4-bis(2-isocyanatoprop-2-yl)benzene (TMXDI), 2,4- and/or 2,6-diisocyanatotoluene (TDI), 2,2′-, 2,4′- and/or 4,4′-diisocyanatodiphenylmethane (MDI), 1,5-diisocyanatonaphthalene, 1,3- and 1,4-bis(isocyanatomethyl)benzene or mixtures thereof. It is self-evident that polyisocyanates can also be used.

Preferred diisocyanates as diisocyanate component A) are 1,6-diisocyanatohexane (HDI), 1-isocyanato-3,3,5-trimethyl-5-isocyanatomethylcyclohexane (isophorone diisocyanate, IPDI), 4,4′-diisocyanatodicyclohexylmethane, 2,4- and/or 2,6-diisocyanatotoluene (TDI) and 2,2′-, 2,4′- and/or 4,4′-diisocyanatodiphenylmethane (MDI).

Particularly preferred diisocyanates as diisocyanate component A) are 2,4′- and/or 4,4′-diisocyanatodiphenylmethane (MDI).

### Polyol Component B);

In the various embodiments of the present invention, a polyol is understood as meaning a polyol with more than one OH group, preferably two terminal OH groups. Such polyols are known to those skilled in the art. Polyesterpolyols are preferred. Suitable polyol components can be prepared in known manner, e.g. from aliphatic hydroxycarboxylic acids or aliphatic and/or aromatic dicarboxylic acids and one or more diols. It is also possible to use appropriate derivatives, e.g. lactones, esters of lower alcohols, or anhydrides. Examples of suitable starting materials are succinic acid, adipic acid, suberic acid, azelaic acid, sebacic acid, dodecanedioic acid, glutaric acid, glutaric anhydride, phthalic acid, isophthalic acid, terephthalic acid, phthalic anhydride, ethylene glycol, diethylene glycol, 1,4-butanediol, 1,6-hexanediol, neopentyl glycol and ε-caprolactone.

At room temperature, polyesterpolyols are either liquid (glass transition temperature Tg<20° C.) or solid, polyesterpolyols that are solid at room temperature being either amorphous (glass transition temperature Tg>20° C.) or crystallizing.

Examples of suitable crystallizing polyesters are those based on linear aliphatic dicarboxylic acids having at least 2 carbon atoms, preferably at least 6 carbon atoms and particularly preferably 6 to 14 carbon atoms in the molecule, e.g. adipic acid, azelaic acid, sebacic acid and dodecanedioic acid, preferably adipic acid and dodecanedioic acid, and on linear diols having at least 2 carbon atoms, preferably at least 4 carbon atoms and particularly preferably 4-6 carbon atoms in the molecule, preferably those having an even number of carbon atoms, e.g. 1,4-butanediol and 1,6-hexanediol. Polycaprolactone derivatives based on bifunctional starter molecules, e.g. 1,6-hexanediol, may also be mentioned as particularly suitable.

Examples of suitable amorphous polyesterpolyols are those based on adipic acid, isophthalic acid, terephthalic acid, ethylene glycol, neopentyl glycol and 3-hydroxy-2,2-dimethylpropyl-3-hydroxy-2,2-dimethylpropanoate.

Examples of suitable polyesterpolyols that are liquid at room temperature are those based on adipic acid, ethylene glycol, 1,6-hexanediol and neopentyl glycol.

Suitable polyetherpolyols are the polyethers conventionally used in polyurethane chemistry, e.g. the addition or mixed addition compounds of tetrahydrofuran, styrene oxide, ethylene oxide, propylene oxide, butylene oxides or epichlorohydrin, preferably of ethylene oxide and/or propylene oxide, prepared using dihydric to hexahydric starter molecules, e.g. water, ethylene glycol, 1,2- or 1,3-propylene glycol, neopentyl glycol, glycerol, trimethylolpropane, pentaerythritol or sorbitol, or amines having 1 to 4 NH bonds. The bifunctional propylene oxide and/or ethylene oxide adducts, and polytetrahydrofuran, may be mentioned as preferred. Such polyetherpolyols and their preparation are known to those skilled in the art.

### Nucleating Agents C):

In the various embodiments of the present invention, a nucleating agent(s) C) is understood as meaning any additive(s) which initiates or favors the formation of a crystalline phase from the melt or solution and/or the growth of crystals onto existing crystal surfaces.

Suitable nucleating agents C) include, e.g., inorganic salts and oxides, such as talc, calcite or attapulgite; colloidal silver or gold; hydrazones; sodium or aluminum benzoates; aluminum, sodium and calcium salts of aromatic or aliphatic/cycloaliphatic acids, e.g. calcium terephthalate; phosphoric acid derivatives or organophosphates; pigments; sorbitols; pine resins; and polymeric nucleating agents, e.g. polycyclopentene or polyvinylcyclohexane, and mixtures thereof.

Examples of suitable nucleating agents C) are sodium chloride, potassium chloride, potassium bromide, titanium dioxide (e.g. of the rutile type), magnesium oxide, zinc oxide, carbon (black), dibenzathrone, copper phthalocyanine, indigo, bis(p-methyl-benzylidene)sorbitol, sodium benzoate or sodium 2,2′-methylbis(4,6-di-tert-butyl-phenyl)phosphate.

Other suitable nucleating agents are described in WO 2005/066256 A1, the entire contents of which are hereby incorporated by reference.

Particularly preferred nucleating agents C) are bis(p-methylbenzylidene)sorbitol, sodium benzoate and sodium 2,2′-methylbis(4,6-di-tert-butylphenyl)phosphate.

Such nucleating agents and their preparation are known to those skilled in the art.

The polyurethane-containing hot-melt adhesives according to the invention can be prepared e.g. by mixing the polyols with an excess of the polyisocyanates and transferring the homogeneous mixture, or stirring said mixture until the NCO value is constant, which usually takes two hours, and then transferring it. The chosen reaction temperature is 60 to 150° C., preferably 80 to 130° C. Of course, the reactive hot-melts can also be prepared continuously in a series of stirred-tank reactors or suitable mixing units, e.g. high-speed mixers operating on the rotor-stator principle, or a static mixer.

It is self-evident that it is possible to modify all or part of the polyesterpolyols and/or polyetherpolyols with an excess of diisocyanates, preferably 1,6-diisocyanatohexane (HDI), 2,4- and/or 2,6-diisocyanatotoluene (TDI) and/or 2,4′- and/or 4,4′-diisocyanatodiphenylmethane (MDI), and, when the reaction has ended, to react the polyols containing urethane groups with an excess of diisocyanates to give a hot-melt containing isocyanate groups.

Likewise, it is possible to carry out the reaction of the polyols with the diisocyanates in the presence of up to 5 wt. % of e.g. trimers of aliphatic diisocyanates, such as HDI, or to add such trimers when the prepolymerization has ended.

### Formulations

As well as the hot-melt adhesive systems according to the invention, conventional additives can also be introduced into the formulations. Appropriate additives can be selected e.g. from the group comprising catalysts that activate the reaction with moisture, other inorganic or organic fillers, dyestuffs, resins, reactive and non-reactive polymers and extending oils.

### Use

The polyurethane-containing hot-melt adhesives according to the invention can have a variety of uses, e.g. as sealants, coatings, foams and adhesives, especially hot-melt adhesives, assembly adhesives for the provisional fixing of components, bookbinding adhesives and adhesives for the production of crossbottom valve sacks, for the production of composite films and laminates or as overlapping edge bands.

The invention will now be described in further detail with reference to the following non-limiting examples.

### EXAMPLES

All percentages are by weight, unless indicated otherwise.

The following polyols were used in the Examples and Comparative Examples:

Polyester A:

Polyesterpolyol based on adipic acid and 1,6-hexanediol, with a hydroxyl number of about 30 mg KOH/g and an acid number of about 0.5 mg KOH/g. It is prepared in a manner known to those skilled in the art, e.g. as described in Ullmann's Encyclopaedia of Chemical Technology, “Polyesters”, 4th edition, Verlag Chemie, Weinheim, 1980.

Polyester B:

Polyesterpolyol based on 1,12-dodecanedioic acid and 1,6-hexanediol, with a hydroxyl number of about 30 mg KOH/g and an acid number of about 1.0 mg KOH/g. It is prepared in a manner known to those skilled in the art, e.g. as described in Ullmann's Encyclopaedia of Chemical Technology, “Polyesters”, 4th edition, Verlag Chemie, Weinheim, 1980.

Polyester C:

Polyesterpolyol based on fumaric acid and 1,6-hexanediol, with a hydroxyl number of about 55 mg KOH/g and an acid number of about 1.2 mg KOH/g. It is prepared in a manner known to those skilled in the art, e.g. as described in DE 102 38 005 A1.

Polyester D:

Polyesterpolyol consisting of the following main components: ethylene glycol, neopentyl glycol, isophthalic acid, adipic acid and terephthalic acid (Desmophen® XP 2462, Bayer MaterialScience AG, Leverkusen, DE), with a hydroxyl number of about 35.0 mg KOH/g and an acid number of about 2.0 mg KOH/g. It is prepared in a manner known to those skilled in the art, e.g. as described in Ullmann's Encyclopaedia of Chemical Technology, “Polyesters”, 4th edition, Verlag Chemie, Weinheim, 1980.

Isocyanate I:

Desmodur® 44M (4,4′-diphenylmethane diisocyanate), Bayer MaterialScience AG, Leverkusen, DE.

Nucleating agent N:

N1: sodium 2,2′-methylbis(4,6-di-tert-butylphenyl)phosphate; Irgastab NA11®, Ciba Spezialitätenchemie Lampertheim GmbH, Lampertheim.

N2: bis(p-methylbenzylidene)sorbitol; Irgaclear DM®, Ciba Spezialitätenchemie Lampertheim GmbH, Lampertheim.

N3: talc; Luzenac A3®, Luzenac Europe, Toulouse, France.

### Preparation of the Reactive PU Hot-Melts (Examples and Comparative Examples):

The proportions of polyol indicated in Table 1 are placed in a 2 1 flat-flange beaker, melted at 130° C. and then dewatered for 1 h at 130° C. and a reduced pressure of 15 mbar (±10 mbar). The appropriate amounts of isocyanate I and nucleating agent N are then added. After being stirred for 20 min, the products are transferred to aluminum cartridges, which are sealed airtight. The cartridges are then tempered for 4 h at 100° C. in a circulating-air drying oven.

TABLE 1
Composition of the Examples and Comparative Examples

| | | Proportion of | Proportion of | Nucleating agent |
|---|---|---|---|---|
| Description | Polyester | polyester [wt. %] | 4,4′-MDI [wt. %] | (0.25 wt. %) |
| Comparative Example 1 | A | 87.21 | 12.79 | — |
| Comparative Example 2 | B | 87.48 | 12.52 | — |
| Comparative Example 3 | C | 81.08 | 18.92 | — |
| Comparative Example 4 | A | 42.88 | 14.23 | — |
| | D | 42.88 | | |
| Comparative Example 5 | C | 41.30 | 17.40 | — |
| | D | 41.30 | | |
| Comparative Example 6 | A | 20.92 | 16.33 | — |
| | C | 20.92 | | |
| | D | 41.83 | | |
| Example 1 | A | 87.00 | 12.75 | N1 |
| Example 2 | B | 87.27 | 12.48 | N1 |
| Example 3 | C | 80.86 | 18.89 | N1 |
| Example 4 | A | 42.77 | 14.21 | N1 |
| | D | 42.77 | | |
| Example 5 | C | 41.19 | 17.37 | N1 |
| | D | 41.19 | | |
| Example 6 | A | 20.86 | 16.31 | N1 |
| | C | 20.86 | | |
| | D | 41.72 | | |
| Example 7 | A | 20.82 | 16.47 | N2 |
| | C | 20.82 | | |
| | D | 41.64 | | |
| Example 8 | A | 20.82 | 16.47 | N3 |
| | C | 20.82 | | |
| | D | 41.64 | | |

Determination of Physical Transitions:

Physical transitions, such as melting points or glass transition temperatures, are determined by measuring the heat tonality with a Pyris Diamond DSC calorimeter from Perkin-Elmer. The temperature is calibrated via indium and lead and the heat tonality via indium. The purge gas used is nitrogen at a flow rate of 30 ml/min. Cooling is effected by means of liquid nitrogen. The temperature gradient is 20 K/min. Measurements are made in the temperature range between −100° C. and +150° C. The initial sample weights are between 9.5 and 11.4 mg of sample in small aluminum pans (normal crucibles). The results are collated in Table 2.

Determination of the Tension Shear Strength of Beechwood Glue Bonds:

The test pieces are produced using beechwood slabs of dimensions 40×20×5 mm, which are stored at 23° C. and 50% relative humidity. The cartridge containing the product to be characterized is melted for 45 minutes at 120° C. in a circulating-air drying oven and the contents are then applied with a cartridge gun as a bead of adhesive to the wood test pieces fixed in a special clamp. The clamp is then closed tight. The clamp guarantees an overlap length of 10 mm, a glueing area of 2 cm² and a glue joint thickness of 0.8 mm. After a defined time, the test pieces are taken out of the clamp and then measured at 23° C. and 50% relative humidity in a tension shear test. To determine the initial strength, the test pieces are tested after 5, 10, 30, 60 and 120 minutes. The ultimate strength is determined after 14 days. 5 test pieces are produced from each product and measured, and the individual results are averaged. The results are collated in Table 3.

Rheological Characterization of the Reactive Polyurethane Hot-Melts:

Before the test, the products, which have been transferred to aluminum cartridges, are melted at approx. 125° C. for approx. 30 ml in a circulating-air oven. The viscoelastic parameters of the polyurethane hot-melts are measured at a fixed frequency of 1 Hz. For measurement at a constant cooling rate, the temperature is lowered from 130° C. to 0° C. at 2° C./min. As the samples shrink on cooling, the measurement must be made with a rheometer equipped with an auto tension function. For the evaluation, the temperature was lowered at two different storage moduli (G′). The upper and lower limits of the Dahlquist band, known from the literature for pressure sensitive adhesives, were chosen for this purpose (G′=5×10⁴ mPas and G′=5×10⁵ mPas).

As the cooling rate of 2 K/min does not correspond to the actual cooling rate of a hot-melt on application, setting measurements are made which have a markedly higher cooling rate. For the setting measurement, the molten, hot PUR hot-melt is quickly transferred to the cold measurement container (at room temperature) and the rheological behavior is measured immediately at room temperature. Accordingly, the cooling rate results from the cooling due to the ambient temperature and is approx. 40-80 K/min in the first minute. The rheological behavior is recorded over time. The time taken to reach a modulus G′ of 1×10⁶ mPas was chosen as a measure of the development of the strength of the system.

The viscoelastic properties of the reactive polyurethane hot-melts are characterized with a VOR-Melt rheometer from BOHLIN Instruments using the oscillation program and the 25HT plate-and-plate system. The instrument is used to characterize the viscoelastic properties of high-viscosity substances such as plastic melts, rubbers, etc., as a function of temperature and frequency.

Results:

The transition temperatures obtained from DSC tests for the pure polyesters and polyesters containing nucleating agents are listed in Table 2. The tension shear strengths from the characterization of beechwood glue bonds are collated in Table 3 and the rheological characterizations are collated in Table 4

TABLE 2
Transition temperatures of polyesters containing
nucleating agents (cooling rate: 2 K/min)

| Polyester | Nucleating agent | Tₘ | T_{cryst} | ΔH_{cryst} |
|---|---|---|---|---|
| A | none | 56.7 | 37.3 | −90.4 |
| A | N1 | 57.4 | 40.8 | −92.8 |
| A | N2 | 56.5 | 39.3 | −90.3 |
| B | none | 71.7 | 54.5 | −116.0 |
| B | N1 | 71.4 | 56.6 | −114.3 |
| B | N2 | 72.0 | 55.8 | −114.3 |

TABLE 3
Tension shear strengths of beechwood glue bonds in N/mm² after
curing at 23° C. and 50% relative humidity and after different curing times

| | | Comp. Ex. 4 | Ex. 4 | Comp. Ex. 5 | Ex. 5 | Comp. Ex. 6 | Ex. 6 | Ex. 7 | Ex. 8 |
|---|---|---|---|---|---|---|---|---|---|
| 5 | min | 0 | 0.35 | 0.58 | 0.64 | 0 | 0 | 0.29 | 0.22 |
| 10 | min | 0.11 | 4.72 | 0.93 | 1.62 | 0 | 0.30 | 0.36 | 0.26 |
| 30 | min | 1.66 | 5.67 | 1.33 | 1.93 | 0.20 | 1.34 | 1.65 | 0.64 |
| 60 | min | 5.82 | 6.53 | 1.51 | 2.07 | 0.38 | 2.15 | 2.23 | 1.65 |
| 120 | min | 6.68 | 5.98 | 2.15 | 4.01 | 0.57 | 2.55 | 5.1 | 5.07 |
| 1 | day | 10.46 | 18.49 | 8.38 | 11.19 | 10.96 | 9.31 | 17.49 | 17.76 |
| 1 | week | 16.65 | 18.1 | 10.06 | 12.19 | 14.15 | 14.53 | 17.02 | 12.22 |
| 2 | weeks | 18.49 | 19.88 | 12.13 | 14.20 | 13.74 | 16.49 | 18.74 | 15.04 |

The results in Table 3 show that the hot-melt adhesive systems according to the invention, containing nucleating agents, have markedly higher tension shear strengths after only 5 minutes. These increased tension shear strengths are particularly pronounced for periods of 10 minutes and 30 minutes. Comparative Examples 4, 5 and 6 can be compared with Examples 4, 5 and 6 according to the invention, because they have the same composition, the nucleating agent N1, i.e. “Irgastab NA11”, being used in each of the Examples according to the invention.

TABLE 4
Cooling behavior of reactive PU hot-melts at different cooling
rates (constant cooling rate of 2 K/min and after setting test
(start temperature 130° C. in each case))

| | Constant cooling rate | | Setting test |
|---|---|---|---|
| | G′ = 5 · 10⁴ Pa | G′ = 5 · 10⁵ Pa | G′ = 1 · 10⁶ |
| | [° C.] | [° C.] | Pa [s] |
| Comparative Example 1 | 39.5 | 38.5 | 34 |
| Example 1 | 45 | 43.5 | 9 |
| Comparative Example 2 | 55.5 | 55 | 5 |
| Example 2 | 59.5 | 59 | 2 |
| Comparative Example 3 | 73 | 72 | 61 |
| Example 3 | 88.5 | 87.5 | 5.3 |
| Comparative Example 4 | 19 | 1 | 1282 |
| Example 4 | 35.5 | 33.5 | 193 |
| Comparative Example 5 | 46 | 26.5 | 157 |
| Example 5 | 58 | 53 | 350 |
| Comparative Example 6 | 31 | 12 | not reached |
| Example 6 | 58.5 | 46.5 | 1540 |
| Example 7 | 47 | 36 | 874 |
| Example 8 | 62.5 | 52 | >2000 |

Discussion of the Results:

Table 2 compares the transition temperatures of the pure polyesters A and B not containing nucleating agents, measured via DSC, with those of the pure polyesters A and B containing nucleating agents N1 and N2. The melting point of polyester B, for example, is 71.7° C. The melting points of polyester B containing nucleating agents N1 and N2 are 71.4° C. and 72.0° C., respectively. This makes it clear that the nucleating agents have no significant influence on the melting point. Likewise, no significant influence is recognizable when considering the crystallization temperatures and heats of crystallization. Since the recrystallization properties of the hot-melt adhesive systems provided according to the invention are essentially based on those of the polyesters, it cannot be assumed, from the results shown in Table 2, that nucleating agents have an influence on the development of initial strength or the strength of the wood material after curing.

Table 3 shows that the tension shear strengths of all the glue bonds (Examples 1 to 8 and Comparative Examples 1 to 6) increase over time. Due to the chemical crosslinking of the hot-melts by atmospheric moisture, the highest strengths are found after 2 weeks, as expected. The adhesive is fully cured after this time. Surprisingly, nucleating agent N1 has a recognizable influence on the ultimate strength. After 2 weeks, all the glue bonds with hot-melts containing nucleating agent N1 (Examples 4, 5 and 6) have a markedly higher tension shear strength than the Comparative Examples not containing nucleating agents (Comparative Examples 4, 5 and 6).

Due to physical phenomena, there is already a recognizable increase in the tension shear strength, i.e. initial strength, of all the glue bonds within the first 2 hours. For example, the strength of Comparative Example 4 increases to 6.68 N/mm² within 120 min.

A comparison of Examples 4-8 with Comparative Examples 4-6 clearly shows the influence of the nucleating agent on the initial strength. For example, an initial strength of 4.72 N/mm² is measured after 10 min for the glue bond with the hot-melt containing nucleating agent N1 (Example 4). The bond with the hot-melt containing nucleating agent N1 (Example 4) is thus 4.61 N/mm² stronger than the bond with the hot-melt not containing nucleating agent N1 (Comparative Example 4). The same effect is also observed for Examples 5, 6, 7 and 8 compared with Comparative Examples 5 and 6. It should be emphasized here that the effect of increased initial and ultimate strengths due to the addition of nucleating agents is most conspicuous for nucleating agent N2 (cf. Example 7 and Comparative Example 6).

The surprisingly greater initial strength of a hot-melt prepared with nucleating agent compared with a hot-melt not containing nucleating agent can also be observed via rheological methods of analysis (Table 4). Table 4 lists the temperatures and times of the Comparative Examples and Examples at defined storage moduli G′ (upper and lower limit of the Dahlquist criterion and G′=1×10⁶ Pa) using different cooling rates (2 K/min and cooling due to room temperature). At a constant cooling rate of 2 K/min, the storage moduli of 5×10⁴ or 5×10⁵ Pa for all the hot-melts containing nucleating agents (Examples 1-8) are reached at higher temperatures than for hot-melts not containing nucleating agents (Comparative Examples 1-6). Thus, in Example 1, the storage modulus G′ of 5×10⁴ Pa is reached at a temperature of 45° C. By contrast, the hot-melt not containing nucleating agent (Comparative Example 1) has to be cooled to around 40° C. in order to reach a strength of 1×10⁴ Pa. This means that, at low cooling rates, there is an observable influence of nucleating agent on the cooling behavior of reactive PUR hot-melts.

The effect of the nucleating agent on the initial strength also becomes clear at high cooling rates (setting test). All the hot-melts containing nucleating agents (Examples 1-8) reach a storage modulus of 1×10⁶ Pa appreciably earlier than the hot-melts not containing nucleating agents (Comparative Examples 1-6). This is particularly pronounced in the case of Example 3 (5.3 sec) and Comparative Example 3 (61 sec).

The presence of nucleating agents in low-molecular NCO-terminated polyurethane prepolymers represents a decisive advantage in terms of application, these systems reaching the Dahlquist range early by virtue of their increased tendency to recrystallize. Thus, compared with the previous systems, they reach adequate initial strengths earlier, so the substrates to be glued can be held in position without mechanical fixing.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A hot-melt adhesive formulation comprising a polyurethane and a nucleating agent.

2. The hot-melt adhesive formulation according to claim 1, wherein the nucleating agent comprises one or more components selected from the group consisting of organic nucleating agents, inorganic nucleating agents, and mixtures thereof.

3. The hot-melt adhesive formulation according to claim 1, wherein the nucleating agent comprises one or more components selected from the group consisting of: inorganic salts and oxides; colloidal silver; colloidal gold; hydrazones; sodium benzoates; aluminum benzoates; aluminum, sodium and calcium salts of aromatic, aliphatic and/or cycloaliphatic acids, phosphoric acid derivatives; organophosphates; pigments; sorbitols; pine resins; polymeric nucleating agents; and mixtures thereof.

4. The hot-melt adhesive formulation according to claim 1, wherein the polyurethane comprises a reaction product of (a) a diisocyanate component and (b) a polyol component, wherein the diisocyanate component comprises one or more selected from the group consisting of aromatic diisocyanates, aliphatic diisocyanates, araliphatic diisocyanates, cycloaliphatic diisocyanates, and mixtures thereof, and wherein (a) and (b) are present in a ratio such that a molar ratio of NCO to OH is greater than 1.

5. The hot-melt adhesive formulation according to claim 4, wherein the nucleating agent is present in an amount of 0.001 to 10 wt. %, based on the sum of (a) and (b).

6. The hot-melt adhesive formulation according to claim 4, wherein the diisocyanate component has an isocyanate content of 5 to 60 wt. %, based on (a).

7. The hot-melt adhesive formulation according to claim 4, wherein the diisocyanate component comprises aliphatically, cycloaliphatically, araliphatically and/or aromatically bonded isocyanate groups.

8. The hot-melt adhesive formulation according to claim 4, wherein the diisocyanate component comprises one or more compounds selected from the group consisting of 1,4-diisocyanatobutane, 1,6-diisocyanatohexane, 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane, 4,4′-diisocyanatodicyclohexylmethane, 1-isocyanato-1-methyl-4(3)-isocyanatomethylcyclohexane, bis(isocyanatomethyl)norbornane, 1,3- and 1,4-bis(2-isocyanatoprop-2-yl)benzene, 2,4- and/or 2,6-diisocyanatotoluene, 2,2′-, 2,4′- and/or 4,4′-diisocyanatodiphenylmethane, 1,5-diisocyanatonaphthalene, 1,3- and 1,4-bis(isocyanatomethyl)benzene, and mixtures thereof.

9. The hot-melt adhesive formulation according to claim 4, wherein the polyol component comprises a polyesterpolyol.

10. The hot-melt adhesive formulation according to claim 4, wherein the polyol component comprises a reaction product of one or more diols and an one or more acids selected from the group consisting of aliphatic hydroxycarboxylic acids, aliphatic dicarboxylic acids, aromatic dicarboxylic acids, and mixtures thereof.

11. The hot-melt adhesive formulation according to claim 4, wherein the polyol component comprises a polyol derivative selected from the group consisting of lactones, esters of lower alcohols, anhydrides and mixtures thereof.

12. A process comprising: providing a polyol component, a diisocyanate component, and a nucleating agent, wherein the diisocyanate component is present in an excess and is selected from aromatic, aliphatic, araliphatic and cycloaliphatic diisocyanates; and mixing the polyol component, the diisocyanate component, and the nucleating agent to form a polyurethane-containing hot-melt adhesive formulation.

13. The process according to claim 12, wherein the mixing is carried out at a temperature of 60 to 150° C.

14. The process according to claim 12, wherein the mixing is carried out continuously in a series of stirred-tank reactors or mixing units.

15. A composition comprising a hot-melt adhesive formulation according to claim 1, and one or more additives selected from the group consisting of catalysts that activate reaction with moisture, fillers, dyestuffs, resins, reactive and non-reactive polymers and extending oils.

16. A process comprising: providing a hot-melt adhesive formulation according to claim 1; and adding one or more additives selected from the group consisting of catalysts that activate reaction with moisture, fillers, dyestuffs, resins, reactive and non-reactive polymers and extending oils to the formulation.

17. A method comprising: providing a hot-melt adhesive formulation according to claim 1; and applying the formulation to one or more components.
